(19) United States
(12) Patent Application Publication
(10) Pub. No.: US 2012/0141896 A1
(43) Pub. Date: Jun. 7, 2012

(54) FUEL CELL SYSTEM AND METHOD OF CONTROLLING THE SAME

(75) Inventors: Se Joon Im, Yongin (KR); Jong Hyun Lee, Yongin (KR)

(73) Assignee: HYUNDAI MOTOR COMPANY, Seoul (KR)

(21) Appl. No.: 13/195,239

(22) Filed: Aug. 1, 2011

(30) Foreign Application Priority Data
Dec. 3, 2010 (KR) 10-2010-0123046

(51) Int. Cl. H01M 8/04

(52) U.S. Cl. 429/429; 429/444

(57) ABSTRACT

Disclosed are a fuel cell system and a method of controlling the system to efficiently remove air flowing into an anode side and a cathode side during a stop of a fuel cell vehicle to prevent an overvoltage of a fuel cell stack that is generated at the time of a start-up thereby enhancing a durability of a fuel cell stack. The fuel cell system illustratively includes a concentration detector mounted at a cathode side and/or an anode side of a fuel cell stack to detect the oxygen concentration in the air; a controller that outputs a control signal to release air when the oxygen concentration is greater than a set value; and an absorber that absorbs air from the cathode side and/or the anode side through an absorption line in response to the control signal output from the controller to thereby release the absorbed air to the outside.

### CROSS-REFERENCE TO RELATED APPLICATION

This application claims under 35 U.S.C. §119(a) the benefit of Korean Patent Application No. 10-2010-0123046 filed Dec. 3, 2010, the entire contents of which are incorporated herein by reference.

### BACKGROUND

(a) Technical Field

The present invention relates to a fuel cell system and a method of controlling the same. More particularly, it relates to a fuel cell system capable of efficiently removing air flowing into an anode side and a cathode side during a stop of a fuel cell vehicle to prevent an overvoltage of a fuel cell stack from generating at the time of a start-up of a fuel cell vehicle thereby enhancing durability of a fuel cell stack, and a method of controlling the same.

(b) Background Art

A fuel cell is an electric power generator that is configured to directly convert a chemical energy of a fuel cell into an electric energy. A polymer electrolyte membrane fuel cell (PEMFC), a fuel cell which is now widely used in vehicles, has been highlighted because of its high efficiency, current density and power density, short start-up time, and a fast response against a load change, as compared with other types of fuel cells.

For a fuel cell to be used as a power source for a fuel cell vehicle, a fuel cell system may be configured in such a manner that a plurality of unit cells of fuel cell are stacked to provide a necessary electric power, and at the same time, various driver devices thereof are integrated into a system together with the stacked cells, and finally the resultant fuel cell system is mounted in a vehicle.

The main configuration of such a fuel cell system for a vehicle comprises a fuel cell stack for generating electric energy through an electrochemical reaction of reaction gas, a hydrogen supplying device for supplying hydrogen as fuel to the fuel cell stack, an air supplying device for supplying to the fuel cell stack air containing oxygen as an oxidant, which is necessary for an electrochemical reaction, and a heat and water controlling device for discharging heat, that is a by-product of electrochemical reaction in the fuel cell, to the outside to control an operation temperature of the fuel cell stack as an optimum temperature and performing a water control function.

From this configuration, the fuel cell stack generates electric energy as a result of electrochemical reaction of oxygen included in the air and hydrogen of reaction gas and discharges heat and water as by-products of the reaction.

Incidentally, if a voltage of the fuel cell stack is higher than a predetermined voltage and hydrogen remains at an anode side and oxygen remains at a cathode side when the system is shut down (e.g., by key-off after stopping a fuel cell vehicle), it has been well known that hydrogen and oxygen are exchanged through an electrolyte membrane thereby accelerating deterioration of a catalyst layer.

To prevent such a phenomenon, various techniques are aimed at removing oxygen and hydrogen at a cathode side and an anode side, respectively, while lowering the voltage of the fuel cell stack, at the time of shutdown of the system.

As a representative example, when the system is shut down, one method used is that a cathode is connected to a load for cathode oxygen depletion (COD), thereby lowering the voltage of the fuel cell stack, and, at the same time, removing oxygen remaining in the cathode side.

However, although the remaining oxygen may be removed by the connection of a load for cathode oxygen depletion at the time of the system shutdown, oxygen in the cathode side cannot be entirely removed if hydrogen remaining in an anode side is not enough to meet the remaining oxygen in the cathode.

Also, valves of an inlet side air discharging conduit and an outlet side air discharging conduit should be closed after completion of the shutdown procedure. In this regard, in a case where a vehicle is parked for a long time even at the valve-closed state, oxygen may flow into the fuel cell stack from the outside to thereby be spread to the anode as well as the cathode.

As a result, there may be a problem that a stack voltage may be generated due to the remaining oxygen at a cathode side in a hydrogen supplying step at the time of the first start-up of a fuel cell vehicle after the parking, thereby unstably increasing the voltage, and carbon corrosion may occur in an electrode catalyst layer of membrane electrode assembly due to oxygen remaining in the anode side, thereby decreasing durability of the stack.

In a common fuel cell system, since the size of the cathode side air discharging conduit is relatively large, air easily flows from the outside into the cathode of the stack through the cathode side conduit, and then is crossed over to the anode side due to a procedure such as diffusion and the like through an electrolyte membrane.

In this manner, under the state where air remains in the anode side, if hydrogen flows into the anode side at the time of a start-up, an interface between hydrogen and air (oxygen) may be created at the anode thereby overvoltage is generated at the cathode side resulting in corrosion in electrode.

As a result, stack performance may be deteriorated after dozens to hundreds of cycles.

In general, overvoltage generation at the time of a start-up of an engine after the air flow into an anode can be prevented by decreasing a voltage by connection with a dummy load such as a resistance and the like. However, it may cause a reverse voltage phenomenon in the cell when hydrogen is unevenly supplied. This may cause a fatal deterioration in the stack performance.

Accordingly, one of the most important processes for enhancing a durability of a fuel cell stack is to prevent or minimize an overvoltage caused by an interface that is formed between hydrogen and air (oxygen) at the time of a start-up of an engine after air (oxygen) flows into an anode during a stop of a fuel cell vehicle.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention relates to a fuel cell system capable of efficiently removing air flowing into an anode side and a cathode side during a stop of a fuel cell vehicle to prevent an overvoltage of a fuel cell stack that is generated at the time of a start-up, thereby enhancing a durability of a fuel cell stack, and a method of controlling the same.

In one aspect to achieve the above object, the present invention provides a fuel cell system including a concentration detector that is mounted at any one or both of a cathode side and an anode side to detect the concentration of oxygen contained in the air at the corresponding side; a controller that outputs a control signal to release air when the concentration of oxygen detected by the concentration detector is greater than a set value; and an absorber that absorbs air from one of the cathode side and the anode side or from both of the cathode side and anode side through an absorption line in response to the control signal output from the controller to thereby release the absorbed air to the outside.

In another aspect, the present invention provides a method comprising: inputting to a controller the concentration of oxygen contained in the air detected by a concentration detector at any one or both of a cathode side and an anode side of a fuel cell stack; outputting from the controller a control signal for discharging air when the concentration of oxygen detected by the concentration detector is greater than a set value; and absorbing and discharging air at one side or both sides of a cathode side and an anode side through an absorption line by an absorber driven in response to a control signal output from the controller.

According to the present invention, there is an effect in that the fuel cell system and the method of controlling the same are capable of efficiently removing air flowing into an anode side and a cathode side during a stop of a fuel cell vehicle to prevent an overvoltage of a fuel cell stack that is generated at the time of a start-up, thereby enhancing a durability of a fuel cell stack.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing a configuration of a fuel cell system according to an exemplary embodiment of the present invention;

FIGS. 2 and 3 are schematic diagrams showing configurations of fuel cell systems according to an another exemplary embodiment of the present invention; and

FIGS. 4a to 4d are views showing problems of fuel cell systems according to a conventional art.

Reference numerals set forth in the Drawings includes reference to the following elements as further discussed below:

1: anode

10: fuel cell stack

12: cathode

13: hydrogen supplying line

15: air supplying line

16: cathode side discharge line

17a, 17b, 18a, 18b: valve

21, 22: concentration detector

23, 24: absorption line

30: controller

41, 42: absorber

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Also, it is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

It is well known that: when starting up a fuel cell system, the higher the concentration of oxygen at an anode of a fuel cell stack, the higher an overvoltage is formed, thereby accelerating corrosion of a cathode electrode As a result, carbon catalyst of a cathode is carried away thereby the cathode decreases in its activity, resulting in a deterioration phenomenon by which performance of a fuel cell is lowered.

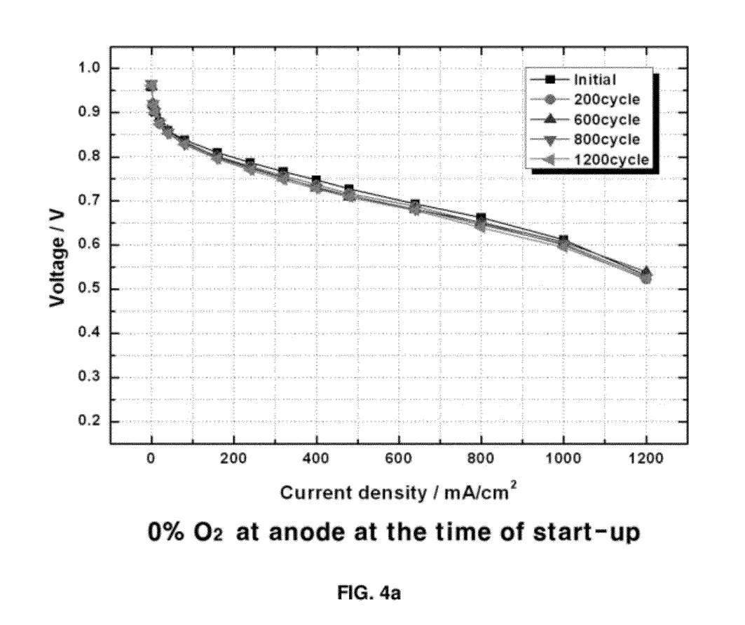

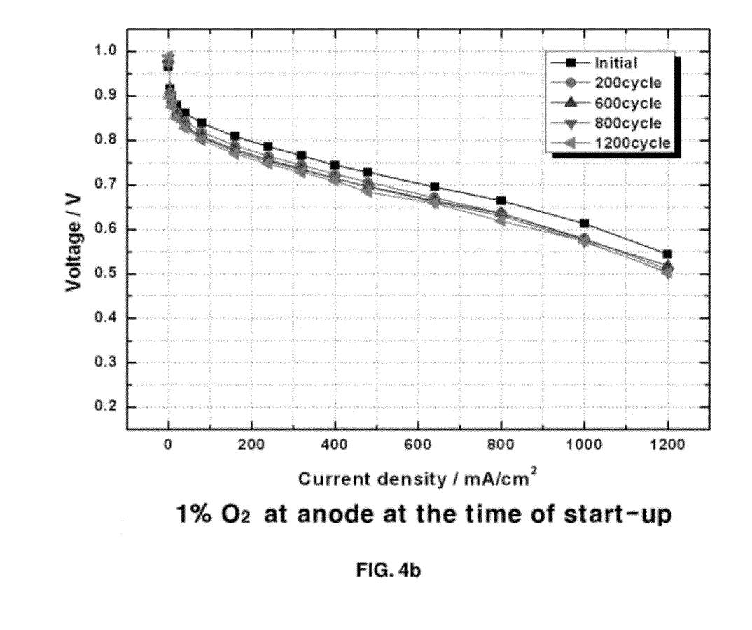

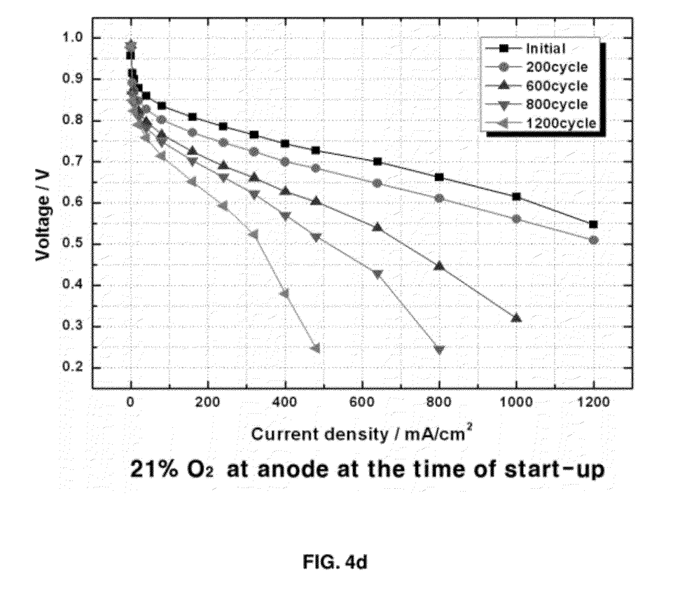

For example, as seen from FIG. 4a and FIG. 4b, in a case where the concentration of oxygen in an anode side is 0% or 1% at the time of a start-up of an engine, there is no phenomenon that a cell voltage drops even though a start-up/stop cycle is repeated. In contrast, as seen from FIG. 4c and FIG. 4d, in a case where the concentration of oxygen in an anode side is more than 10% or 20% at the time of a start-up of an engine, the more a start-up/stop cycle is repeated, the more a cell voltage drops. As a result, the durability of the fuel cell stack is deteriorated and the total system becomes unstable thus causing a frequent shutdown of the system.

Accordingly, a main object of the present invention is to efficiently remove air flowing into an anode side and a cathode side during a stop of a fuel cell vehicle (shutdown of a fuel cell system) to prevent an overvoltage in a fuel cell stack from being generated at the time of a start-up, thereby improving a durability of the fuel cell stack.

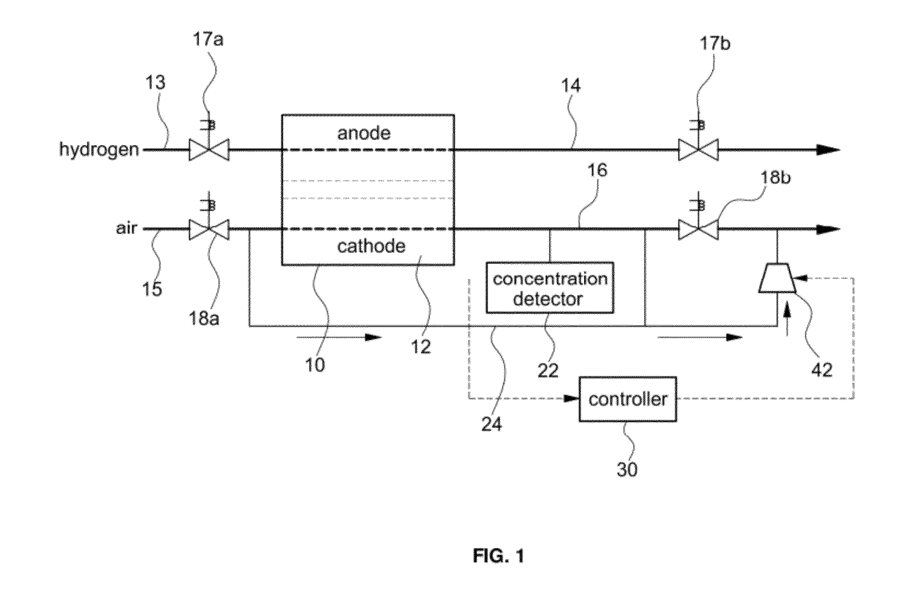

FIG. 1 is a schematic diagram showing an example configuration of a fuel cell system according to an illustrative embodiment of the present invention.

As shown in the drawing, the system includes piping lines (13, 14, 15, and 16) connected to a fuel cell stack 10. In the piping lines, valves 17a, 17b, 18a, 18b each are mounted in a hydrogen supplying line 13 connected to an anode inlet of the stack 10, an anode side discharge line 14 connected to an anode outlet, an air supplying line 15 connected to an inlet of the cathode 12, and a cathode side discharge line 16 connected to the cathode outlet, respectively.

In the illustrative fuel cell system configured as shown, the valves 17a and 17b, which are mounted at an inlet port and an outlet port of the fuel cell stack 10, and the valves 18a, 18b, which are mounted at an inlet port and an outlet port of the cathode, are designed to be closed at the time of a shutdown of a fuel cell system (during a stop of a fuel cell system) to cut off supplying of reaction gases (hydrogen and oxygen) into the fuel cell stack. However, as noted above, if a fuel cell vehicle stops and the system is accordingly shut down for a long time, a small amount of air flows into the stack through each of the conduits and the like.

Particularly, even though the cathode side conduit of a common fuel cell system, that is, the air supplying line 15 and the cathode side discharge line 16, are large in size and even though each of the valves 18a and 18b is closed during a stop of a vehicle, a great amount of air may flow into the stack through the cathode side conduit from the outside.

In this manner, the outside air that has flowed into the cathode 12 passes through a membrane electrode assembly and a gas diffusion layer to be crossed over at the anode 11, thereby causing generation of an overvoltage and corrosion at the electrode.

Accordingly, as shown in FIG. 1, to efficiently remove air flowing into the cathode 12 side of the stack 10 during a stop of a vehicle, a fuel cell system according to the present invention includes a concentration detector 22 for detecting the concentration of oxygen contained in the air at the cathode side of a cathode manifold (cathode 12) and conduit and so on; a controller 30 for outputting a control signal to release air when the concentration of oxygen detected by the concentration detector 22 is determined to be greater than a particular set value (e.g., 10% oxygen at the anode); and an absorber 42 that operates in response to a control signal output from the controller 30 to absorb air from the cathode 12 through an absorption line 24 connected to the cathode 12 side thereby outputting the absorbed air to the outside.

Herein, the concentration detector 22 may be mounted at the cathode 12 at the inlet port or outlet port of the fuel cell stack 10, that is, at the inlet manifold, outlet manifold, or the cathode side discharge line 16, and the absorber 42 may be mounted at the cathode manifold of the stack 10 or at the absorption line 24 connected to the cathode 12 conduit, thereby absorbing air at the cathode side of the fuel cell stack 10 through the absorption line 24 at the time of a start-up and discharging the absorbed air to the outside.

The absorber 42 may be replaced with any conventional absorbers if the conventional absorbers have a function capable of absorbing air flowing into the cathode 12 and discharging the absorbed air to the outside.

For example, a vacuum pump, otherwise, a gas discharging apparatus having absorption and decompression function, may be possible to be used as the absorber 42 of the present invention.

The air absorbed by the absorber 42 is discharged to the outside of the stack through a separate discharge conduit connected to the outlet side of the absorber 42. At this time, as shown in FIG. 1, a discharge conduit of the absorber 42 may be connected to a backside of the valve 18b on the cathode side discharge line 16 so that air may be finally discharged to the outside through the cathode side discharge line 16.

Also, the absorption line 24 connected to an absorption inlet side of the absorber 42 may be connected to any one or both of an inlet port (cathode inlet manifold or air supplying line) of the cathode 12 and an outlet port (outlet manifold or cathode side discharge line) of the cathode 12 in the fuel cell stack 10, as shown in FIG. 1, such that the absorber 42 may absorb air at both sides of the inlet port or outlet port of the cathode to release the absorbed air to the outside.

Incidentally, since the present invention releases air flowing into the stack 10 to the outside, it is preferable that the absorption line 24 is connected to a piping position and manifold that are closed by the valves 18a, 18b of the inlet port and outlet port of the cathode, that is, to any one of the air supplying line 15, cathode side discharge line 16, cathode side inlet manifold of the stack, and cathode side outlet manifold.

Also, it is preferable that the concentration detector 22 is mounted on any one of a manifold of the stack that is closed by the valves 18a, 18b of inlet port and outlet port of the cathode and a gas discharge conduit connected to the manifold.

The exemplary embodiment shown in FIG. 1 shows a system for discharging air of a cathode side (air side). Accordingly, the system is configured in such a manner that the concentration detector 22 detects the concentration of oxygen only during a shutdown of the fuel cell system and the controller 30 is set to activate the absorber 42 to operate only when the detected concentration of oxygen is greater than a set value. In this case, it is possible to reduce power consumption in the absorber.

In more detail, when the concentration detector 22 detects the concentration of oxygen of more than a set value during a shutdown of a fuel cell system (a stop of a vehicle), the controller activates the absorber 42 to operate to release air flowing into the cathode 12 side of the fuel cell stack 10 to the outside. In this manner, since the absorber 42 operates before a start-up of a vehicle, the start-up process may be proceeded in a manner that hydrogen is supplied to an anode 11 while the concentration of oxygen contained in the cathode 12 side is maintained below a set value. As a result, since air is discharged from the cathode before hydrogen is supplied to the anode after a vehicle has stopped for a long time and accordingly the fuel cell stack 10 has been maintained in a shutdown state for a long time, the system according to the present invention may overcome the above-mentioned conventional problems such as a formation of a hydrogen/oxygen interface that may be created during a start-up of a vehicle, generation of an overvoltage that may be caused by the interface, carbon corrosion, and electrode damage and so on.

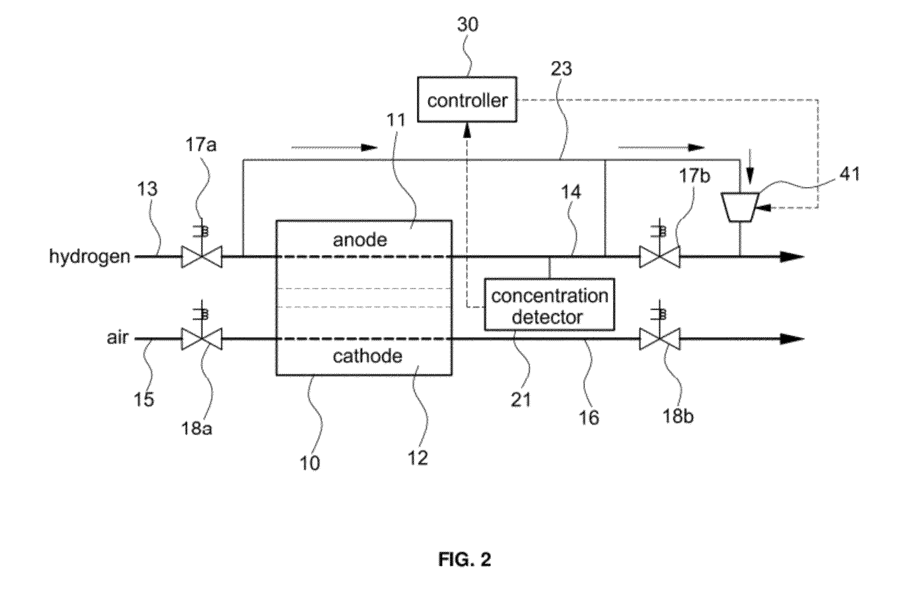

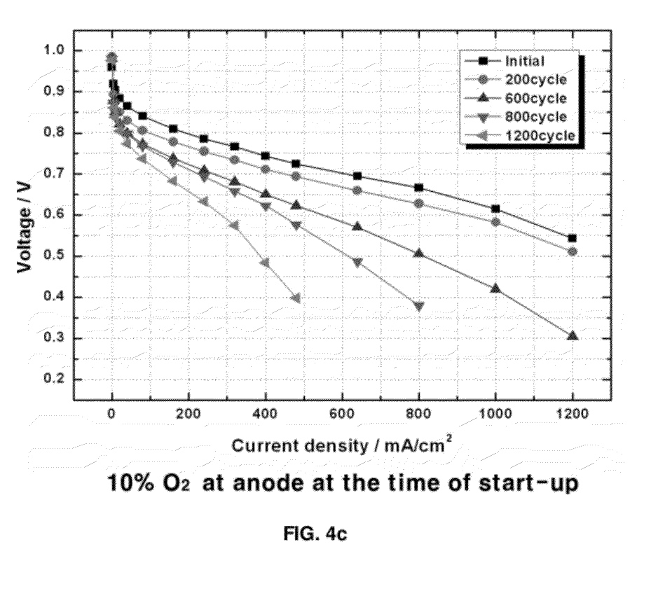

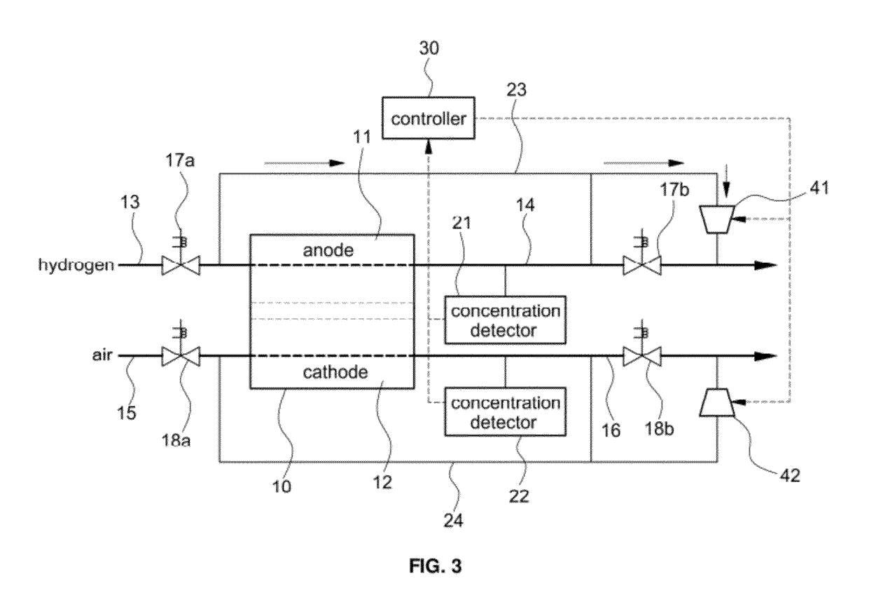

FIGS. 2 and 3 are schematic diagrams showing configurations of fuel cell systems according to another exemplary embodiment of the present invention.

The embodiment shown in FIG. 2 differs from the embodiment shown in FIG. 1 in that the concentration detector, absorber, absorption line shown in FIG. 1 are mounted in an anode side, not a cathode side, but the concentration detector 21, absorber 41, absorption line 23 and controller 30 are identical in its role to those shown in FIG. 1.

In the embodiment shown in FIG. 2, in a case where the concentration of oxygen detected by the concentration detector 21 is greater than a set value, the controller activates the absorber 41 to operate to release air flowing into the anode 11 side of the stack 10 to the outside.

The concentration detector 21 may be mounted at an inlet port of the anode 11 or an outlet port of the stack 10, e.g., the hydrogen supplying line 13, inlet manifold, outlet manifold, or, anode side discharge line 14. The absorber 41 may be mounted at an anode manifold of the stack 10 or an absorption line 23 connected to an anode side discharge conduit to absorb air of the anode 11 side of the stack 10 through the absorption line 23 thereby discharging the absorbed air to the outside.

The air absorbed by the absorber 41 is discharged to the outside of the stack through a separate discharge conduit connected to the outlet side of the absorber. As shown in FIG. 2, a discharge conduit of the absorber 41 is connected to a back side of the valve 17b on the anode side discharge line 14 thereby finally discharging air through an anode side discharge line.

Also, the absorption line 21 connected to an inlet side of the absorber 41 may be connected to any one or both of an inlet port (anode inlet manifold or hydrogen supplying line) of the anode 11 of the stack 10 and an outlet port (outlet manifold or anode side discharge line) of the anode 11.

Since the exemplary embodiment shown in FIG. 2 is associated with a system for discharging air of the anode 11 side (hydrogen side), in a case where the concentration of oxygen is greater than a set value during a stop of a vehicle or at the time of a start-up of a vehicle, the controller 30 may be designed to activate the absorber 41 to operate. When starting a vehicle up, the controller 30 activates the absorber 41 to operate before hydrogen is supplied thereby lowering the concentration of oxygen of the anode side to below a set value, and then supplying hydrogen.

In the exemplary embodiment of FIG. 3, the concentration detector, absorber, and absorption line shown in FIG. 1 are added even to the anode side. The exemplary embodiment of FIG. 3 differs from the exemplary embodiment of FIG. 1 in that the concentration detector, absorber, and absorption line are mounted on both of the anode 11 side and the cathode 12 side, but the concentration detectors 21, 22, absorbers 41, 42, absorption lines 23, 24 and controller 30 take the same role as in the embodiment of FIG. 1.

Particularly, in the exemplary embodiment shown in FIG. 3, the system is configured to include the concentration detector 21, absorber 41 and absorption line 23 which are shown in FIG. 2 in addition to the concentration detector 22, absorber 42 and absorption line 24 which are shown in FIG. 1, thereby absorbing and discharging inflow air at both sides of the anode 11 side and the cathode 12 side.

In this case, a set value of the concentration of oxygen at the anode 11 side may be determined differently from a set value of the concentration of oxygen at the cathode 12 side, which become a basis for determining whether to operate the absorbers 41, 42.

Even in the exemplary embodiment shown in FIG. 3, the controller 30 may be designed to activate the concentration of oxygen of the anode 11 side to be checked by the concentration detector 21 only at the time of a start-up, and to activate the absorber 41 to operate when the concentration of oxygen is detected as being more than a set value. That is, the controller 30 serves to activate the absorber 41 to operate before hydrogen is supplied at the time of a start-up thereby lowering the concentration of oxygen of the anode 11 side to below a set value, and then supplying hydrogen. In this case, the operation of the absorber results in minimizing power consumption.

Notably, if the concentration of oxygen in the stack is less than a set value, the fuel cell system may start up according to a common start-up process even without the operation of the absorber 41.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A fuel cell system comprising:
a concentration detector that is mounted at any one or both of a cathode side and an anode side of a fuel cell stack to detect the concentration of oxygen contained in air at the corresponding side;
a controller that outputs a control signal to release air from the corresponding side when the concentration of oxygen detected by the concentration detector is greater than a set value at the corresponding side; and
an absorber that absorbs air from one or both of the cathode side and the anode side through an absorption line in response to the control signal output from the controller to thereby release the absorbed air to outside of the system.

2. The fuel cell system according to claim 1, wherein the concentration detector is mounted at any one of i) a manifold of a fuel cell stack that is closed by a valve of an inlet port and a valve of an outlet port of a fuel cell stack, ii) a gas conduit connected to a manifold of the fuel cell stack at a cathode side, and iii) a gas conduit connected to a manifold of the fuel cell stack at an anode side.

3. The fuel cell system according to claim 1, wherein the absorption line is connected as an air absorption position to at least one of i) an inlet port of a fuel cell stack at the cathode side, ii) an outlet port of a fuel cell stack at the cathode side, iii) an inlet port of a fuel cell stack at the anode side, and iv) an outlet port of a fuel cell stack at the anode side.

4. The fuel cell system according to claim 3, wherein the absorption line is connected to at least one of i) a manifold of a fuel cell stack or ii) a gas conduit which is closed by a valve of an inlet port and an outlet port of a fuel cell stack.

5. The fuel cell system according to claim 1, wherein the controller activates the absorber to operate if the concentration of oxygen detected by the concentration detector is greater than a set value for at least one of i) during a shutdown of the fuel cell system, or ii) at the time of a start-up of the fuel cell system.

6. The fuel cell system according to claim 1, wherein a discharge conduit of the absorber is connected to a back side of a valve at one or both of a cathode side discharge line or an anode side discharge line, wherein the absorbed air is correspondingly released through the cathode side discharge line or the anode side discharge line.

7. A method of controlling a fuel cell system comprising:
inputting, to a controller, a concentration of oxygen contained in air detected by a concentration detector at any one or both of a cathode side and an anode side of a fuel cell stack;
outputting from the controller a control signal for discharging air from the corresponding side when the concentration of oxygen detected by the concentration detector is greater than a set value at the corresponding side; and
absorbing and discharging air at the corresponding side through an absorption line by an absorber driven in response to the control signal output from the controller.

8. The method of controlling a fuel cell system according to claim 7, further comprising: activating the absorber to operate if the concentration of oxygen detected by the concentration detector is greater than a set value for at least one of i) during a shutdown of the fuel cell system, or ii) at the time of a start-up of the fuel cell system.

9. The method of controlling a fuel cell system according to claim 8, further comprising: activating the concentration detector to check the concentration of oxygen and activating the absorber to operate in response to a shutdown of the fuel cell system associated with the concentration detector, absorption line, and absorber which are mounted at a cathode side of the fuel cell stack.

10. The method of controlling a fuel cell system according to claim 8, further comprising: activating the concentration detector to check the concentration of oxygen and activating the absorber to operate in response to a start-up of the fuel cell system associated with the concentration detector, absorption line, and absorber which are mounted at an anode side of the fuel cell stack.

11. The method of controlling a fuel cell system according to claim 10, further comprising:
activating the absorber to operate at the time of a start-up of the fuel cell system to lower the concentration of oxygen; and
subsequently supplying hydrogen to the anode side of the fuel cell stack.

12. The method of controlling a fuel cell system according to claim 8, further comprising:
activating the absorber to operate at the time of a start-up of the fuel cell system to lower the concentration of oxygen; and
subsequently supplying hydrogen to the anode side of the fuel cell stack.

13. A method, comprising:
detecting a concentration of oxygen in air at one or both of a cathode side and an anode side of a fuel cell;
determining whether the concentration of oxygen is greater than a set value; and
discharging air from the corresponding side in response to the concentration of oxygen being greater than the set value.

14. The method according to claim 13, wherein the detecting, determining, and discharging occur during a shutdown of the fuel cell.

15. The method according to claim 13, wherein the detecting, determining, and discharging occur during a start-up of the fuel cell, the method further comprising:
supplying hydrogen to the anode side of the fuel cell subsequent to discharging the air.
